(19) United States
(12) Patent Application Publication
(10) Pub. No.: US 2016/0355766 A1
(43) Pub. Date: Dec. 8, 2016

(54) COMPACTED LIQUID LAUNDRY DETERGENT COMPOSITION

(71) Applicant: The Procter & Gamble Company, Cincinnati, OH (US)

(72) Inventors: Alan Thomas BROOKER, Newcastle upon Tyne (GB); Philip Frank SOUTER, Northumberland (GB); Nigel Patrick SOMERVILLE-ROBERTS, Newcastle upon Tyne (GB); Dan XU, Newcastle upon Tyne (GB); Jeremie Robert Marcel GUMMEL, Newcastle upon Tyne (GB)

(21) Appl. No.: 15/170,966

(22) Filed: Jun. 2, 2016

(30) Foreign Application Priority Data
Jun. 5, 2015 (EP) 15170782.5
Mar. 3, 2016 (EP) 16158399.2

(51) Int. Cl. C11D 17/00; C11D 3/50; C11D 1/22; C11D 1/14; C11D 17/04; C11D 3/20

(52) U.S. Cl. CPC C11D 17/0013; C11D 17/043; C11D 17/045; C11D 3/2068; C11D 3/2041; C11D 3/2065; C11D 1/22; C11D 1/14; C11D 3/50

(57) ABSTRACT

A liquid laundry detergent composition that includes: a liquid phase; and a water-soluble solid phase, where the solid phase includes a cleaning active.

### FIELD OF THE INVENTION

The present invention is to the field of liquid laundry detergent compositions and their methods of use.

### BACKGROUND OF THE INVENTION

Liquid laundry detergent compositions with low equilibrium relative humidities have the advantage of being less susceptible to microbial contamination. There is also a trend towards so called compacted liquids that minimise the presence of unnecessary ‘filler’ liquids such as water. Such compositions are more environmentally friendly as less unnecessary material needs to be transported, so reducing the environmental impact of such transport operations.

However, such compacted composition can often have high viscosities due to the high relative concentration of the cleaning materials such as anionic surfactants. Traditionally, hydroxyl-containing amines have been used in such compositions to ensure consumer acceptable viscosity of the liquid laundry detergent composition. Also, acceptable viscosity is required to allow processability of the composition during manufacture. The hydroxyl-containing amines are often used as neutralising agents for the anionic detergent surfactants such as linear alkylbenzene sulphonate.

However, there is now a desire to reduce the overall level of such hydroxyl-containing amines.

Reduction in the level of the hydroxyl-containing amines of known low relative humidity laundry detergent compositions can result in high viscosity of the composition which negatively impacts the ability of the consumer to accurately pour and dose the composition. Also, processability of the composition is impacted as it is difficult to handle such viscous compositions during manufacture.

Thus, there is a need in the art for low relative humidity liquid laundry detergent compositions containing lower levels of hydroxyl-containing amine compounds, but which exhibit consumer acceptable and/or process acceptable viscosities.

It has been surprisingly found that the above problems are overcome by the specific formulation space of the present invention. The formulation space described below can provide a liquid composition having a low relative humidity and comprising lower levels of hydroxyl-containing amine compounds but which has acceptable viscosity.

### SUMMARY OF THE INVENTION

The present invention is also to a liquid laundry detergent composition of the present invention may comprise
a. a liquid phase;
b. between 10% and 50% by weight of the composition of a water-soluble solid phase, wherein the solid phase comprises at least 30% by weight of the solid phase of a cleaning active, wherein the cleaning active comprises between 50% and 90% by weight of the cleaning active of a surfactant and between 10% and 20% by weight of the cleaning active of non-surfactant cleaning active, wherein the solid phase is dispersed within the liquid phase and wherein the water-soluble solid phase is defined as the solid obtained when the liquid laundry detergent composition is centrifuged at 1200 G for 10 mins; and

wherein the liquid phase comprises between 5% and 40% by weight of the liquid of an alcohol selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof, preferably the alcohol is selected from the group comprising 1,2 propanediol, dipropylene glycol, polypropylene glycol, 2,3- butane diol, dipropylene glycol n-butyl ether and mixtures thereof; and

wherein the composition comprises from 10% to 50% by weight of the composition of a non-amine neutralised anionic surfactant and wherein the liquid laundry detergent composition comprises less than 10% by weight of the liquid laundry detergent composition of an amine-neutralised anionic surfactant; and

wherein the composition has an equilibrium relative humidity of less than 65% at 20° C. as measured via the composition eRH test described herein; and

wherein the composition comprises less than 5% by weight of the composition of a hydroxyl-containing amine compound.

### DETAILED DESCRIPTION OF THE INVENTION

### Laundry Detergent Composition

The liquid laundry detergent composition of the present invention comprises a liquid phase and a water-soluble solid phase. The solid phase is dispersed within the liquid phase, and comprises between 10% and 50%, or even between 10% and 40% by weight of the composition of the water-soluble solid phase. The solid phase comprises at least 30% by weight of the solid phase of a cleaning active, wherein the cleaning active comprises between 50% and 90% by weight of the cleaning active of a surfactant and between 10% and 20% by weight of the cleaning active of non-surfactant cleaning active. Suitable surfactants and cleaning actives are described in more detail below. The solid phase and liquid phases are described in more detail below.

Preferably, the liquid laundry detergent composition has a viscosity of between 300 mPa·s and 700 mPa·s, more preferably between 350 mPa·s and 600 mPa·s at a shear rate of 1000 s⁻¹. An exemplary method for measuring viscosity is to use a Rheometer DHR1 from TA instruments using a gap of 1000 μm at 20° C. as according to the manufacturer's instructions.

The liquid laundry detergent composition of the present invention overall is liquid in nature. That is to say, even though it comprises a solid phase dispersed within a liquid phase, the composition has the nature of a liquid rather than a solid or granular composition. In relation to the laundry detergent composition of the present invention, the term ‘liquid’ encompasses forms such as dispersions, gels, pastes and the like. The liquid composition may also include gases in suitably subdivided form. However, the liquid composition excludes forms which are non-liquid overall, such as tablets or granules.

The term ‘liquid laundry detergent composition’ refers to any laundry detergent composition comprising a liquid capable of wetting and treating fabric e.g., cleaning clothing in a domestic washing machine,

The liquid composition may be formulated into a unit dose article. The unit dose article of the present invention comprises a water-soluble film which fully encloses the liquid composition in at least one compartment. Suitable unit dose articles are described in more detail below.

The liquid laundry detergent composition can be used as a fully formulated consumer product, or may be added to one or more further ingredient to form a fully formulated consumer product. The liquid laundry detergent composition may be a ‘pre-treat’ composition which is added to a fabric, preferably a fabric stain, ahead of the fabric being added to a wash liquor.

The liquid laundry detergent composition comprises from 10% to 50% by weight of the composition of a non-amine neutralised anionic surfactant. Suitable non-amine neutralised anionic surfactants are described in more detail below. The cleaning agent present within the solid phase may comprise the non-amine neutralised anionic surfactant. The solid phase may comprise at least 30% by weight of the solid phase of the non-amine neutralised anionic surfactant and overall the liquid laundry detergent composition comprises from 10% to 50% by weight of the composition of the non-amine neutralised anionic surfactant. Alternatively, the liquid phase may comprise a non-amine neutralised anionic surfactant and the cleaning agent may comprise a non-amine neutralised anionic surfactant and overall the liquid laundry detergent composition comprises from 10% to 50% by weight of the composition of the non-amine neutralised anionic surfactant. Alternatively, the liquid phase may comprise a non-amine neutralised anionic surfactant and overall the liquid laundry detergent composition comprises from 10% to 50% by weight of the composition of the non-amine neutralised anionic surfactant.

The liquid laundry detergent composition comprises less than 10% by weight, or even less than 5% by weight, or even less than 2% by weight of the liquid laundry detergent composition of an amine-neutralised anionic surfactant, wherein the anionic surfactant is preferably selected from the group comprising linear alkylbenzene sulphonate, alkyl sulphate and mixtures thereof.

The liquid laundry detergent composition comprises between 0.5% and 50% by weight of the composition of water and has an equilibrium relative humidity of less than 65% at 20° C.

The composition comprises less than 5% by weight of the composition of a hydroxyl-containing amine compound. Suitable amines are described in more detail below.

The liquid laundry detergent composition may comprise a structurant. Suitable structurants are described in more detail below.

The liquid laundry detergent composition may comprise a silica.

The liquid laundry detergent composition may comprise a perfume raw material. The perfume raw material is preferably selected from aldehydes, ketones or a mixture thereof.

The liquid laundry detergent composition of the present invention may comprise adjunct ingredients, wherein the adjunct ingredients are present in the solid phase, the liquid phase or both.

Without wishing to be bound by theory, it is believed that the removal of the hydroxyl-containing amine compounds results in a number of detergent ingredients, such as anionic surfactants to come out of solution. This in turn results in increase viscosity of the composition. The present invention is to a formulation space wherein certain ingredients are present as solid material dispersed within the liquid but the viscosity of the liquid laundry detergent composition is returned to a manageable level.

Furthermore, removal of the hydroxyl-containing amine can cause the formulation to phase split (i.e. at least two visibly distinct phases can be seen). The present invention provides the additional benefit of providing a composition having a low relative humidity and lower levels of hydroxyl-containing amine compounds, whilst minimising phase splitting.

### Solid Phase

The liquid laundry detergent composition of the present invention comprises a water-soluble solid phase, wherein the solid phase is dispersed in the liquid phase.

By ‘solid phase’ we herein mean any material that is solid, i.e. not liquid. The solid phase may comprise particles. The term ‘particles’ is herein used in its broadest meaning. The term ‘particles’ may include crystals, lamellar liquid crystals or mixtures thereof. The particles may have a mean particle size distribution of between 2 μm and 50 μm.

By ‘water-soluble’ we herein mean at least 75%, or even at least 85% or even at least 95% of the solid dissolves in water as measured by the method set out here after using a glass-filter with a maximum pore size of 20 microns:

5 grams ±0.1 gram of solid is added in a pre-weighed 3L beaker and 2L ±5 ml of distilled water is added. This is stirred vigorously on a magnetic stirrer, Labline model No. 1250 or equivalent and 15 cm magnetic stirrer, set at 600 rpm, for 30 minutes at 35° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

The water-soluble solid phase consists of any material obtained in the solid fraction when the liquid laundry detergent composition is centrifuged at 1200 G for 10 mins. A preferred method is;
1. Before use, pre heat the centrifuge (Sigma Centrifuge 6-15H, 6-pot rotor) to the desired temperature. When loading centrifuge tubes into the rotor, they should always be placed opposite each other in diametrically opposed positions, number of samples can be tested are 2, 3, 4 and 6.
2. 85 ml polycarbonate with screw lids test tubes are used. Each tube was filled with 50 g of material and the total mass: tube+lid+testing material measured
3. Place the tubes in the centrifuge rotor so that they are evenly spaced, and fasten the rotor cover firmly. When loading centrifuge tubes into the rotor, they should always be placed opposite each other in diametrically opposed positions, number of samples can be tested are 2, 3, 4 and 6.
4. Set the centrifuge time to 90 minutes. Start the centrifuge (it will gradually increase the speed automatically until 17119 Relative Centrifugal Force (Maximum RCF for this centrifuge is used to maximise the separation rate) is achieved.
5. At the end of the 90 minutes, reweigh each tube to ensure that no material has been lost, as centrifuge tubes can crack after several uses.
6. Different fractions can result at end of the centrifugation and the number of fractions depends on the nature of the sample, solid fraction is the most dense, opaque fraction at the bottom and the relative high viscosity. The bottom fraction can then be obtained by simply removing the top phase(s) from the tube.

The water-soluble solid phase comprises at least 30% by weight of the solid phase of a cleaning active. The solid phase may comprise at least 40%, or even at least 50% by weight of the solid phase of a cleaning active. Suitable cleaning actives are described in more detail below.

The liquid laundry detergent composition comprises between 10% and 50%, or even between 10% and 40% by weight of the liquid laundry detergent composition of the water-soluble solid phase.

The solid phase may comprise non-cleaning active. The solid phase may comprise both a cleaning active and a non-cleaning active. Non-cleaning actives include ingredients that provide aesthetic or sensorial benefits, or those classed as filler materials. For example, non-cleaning actives include clays, perfumes, perfume delivery technologies, softness technologies, pigments, silicones, antifoams, deposition-enhancement technologies and the like. Filler materials can include materials such as carbonate, sulphate silicate or a mixture thereof.

### Liquid Phase

The liquid laundry detergent composition of the present invention comprises a liquid phase into which the solid phase is dispersed.

The liquid phase comprises between 5% and 40% by weight of the composition of an alcohol. The alcohol is described in more detail below.

The liquid phase may comprise an alkyl sulphate anionic surfactant. The alkyl sulphate anionic surfactant may be alkoxylated or non-alkoxylated or a mixture thereof. The alkyl sulphate anionic surfactant may be a C₁₀-C₂₀ primary, branched-chain and random alkyl sulfates (AS), including predominantly C₁₂ alkyl sulfates. Alternatively, the alkyl sulphate anionic surfactant may be a C₁₀-C₁₈ secondary (2,3) alkyl sulfates. Alternatively, the alkyl sulphate anionic surfactant may be a C₁₀-C₁₈ alkyl alkoxy sulfates (AEₓS) wherein x is from 1-30. Alternatively, the alkyl sulphate anionic surfactant may be a mixture of all the above alkyl sulphate anionic surfactants. Non-limiting examples of suitable cations for the alkyl sulphate anionic surfactant include sodium, potassium, ammonium, amine and mixtures thereof. Preferably, the composition comprises between 5% and 35%, or even between 10% and 30% by weight of the composition of alkyl sulphate anionic surfactant.

The liquid phase may comprise a natural or synthetically derived fatty alcohol ethoxylate non-ionic surfactant. Preferred synthetically derived fatty alcohol ethoxylate non-ionic surfactant or those derived from the oxo-synthesis process, or so-called oxo-synthesised non-ionic surfactants. The composition may comprise from 0% to 30% or even from 0.1% to 25% by weight of the composition of fatty alcohol ethoxylate non-ionic surfactant.

The ethoxylated nonionic surfactant may be, e.g., primary and secondary alcohol ethoxylates, especially the C₈-C₂₀ aliphatic alcohols ethoxylated with an average of from 1 to 50 or even 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

The ethoxylated alcohol non-ionic surfactant can be, for example, a condensation product of from 3 to 8 mol of ethylene oxide with 1 mol of a primary alcohol having from 9 to 15 carbon atoms.

The non-ionic surfactant may comprise a fatty alcohol ethoxylate of formula R(EO)ₙ, wherein R represents an alkyl chain between 4 and 30 carbon atoms, (EO) represents one unit of ethylene oxide monomer and n has an average value between 0.5 and 20.

The composition may comprise other non-ionic surfactants, preferably natural or synthetic non-ionic surfactants.

### Alcohol

The liquid phase comprises between 5% and 40%, or even between 5% and 20% or even between 5% and 15% by weight of the composition of an alcohol, wherein preferably the alcohol has a molecular weight of between 20 and 400 and an eRH of between 50% and 80%, or even between 52% and 75% at 20° C. as measured via the alcohol eRH test.

The alcohol eRH test comprises the steps of preparing a solution of 80% alcohol in deionised water, followed by adding this to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

By ‘alcohol’ we herein mean either a single compound or a mixture of compounds that when taken together collectively each have a molecular weight of between 20 and 400 and an overall eRH of the compound or mixture of between 50% and 80% at 20° C. as measured via the alcohol eRH test. Without wishing to be bound by theory, an alcohol is any compound comprising at least one OH unit, preferably polyols and diols, more preferably diols. Preferred diols included glycols

The alcohol may be selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof.

More preferably, the alcohol may be selected from the group comprising ethylene glycol, 1,2 propanediol, 2,3-butane diol, 1,3 butanediol, triethylene glycol, polyethylene glycol, glycerol formal, dipropylene glycol, polypropylene glycol, dipropylene glycol n-butyl ether, and mixtures thereof.

Even more preferably the alcohol is selected from the group comprising 1,2 propanediol, dipropylene glycol, polypropylene glycol, 2,3- butane diol, dipropylene glycol n-butyl ether and mixtures thereof.

Most preferably, the alcohol may be selected from the group comprising 1,2 propanediol, dipropylene glycol, polypropylene glycol, dipropylene glycol n-butyl ether and mixtures thereof.

### Cleaning Active

The water-soluble solid phase comprises at least 30% by weight of the solid phase of a cleaning active. The solid phase may comprise at least 40%, or even at least 50% by weight of the solid phase of a cleaning active.

By ‘cleaning active’ we herein mean an ingredient that provides some kind of cleaning benefit to a substrate, preferably a fabric. Cleaning actives do not include ingredients that provide simply aesthetic or sensorial benefits, or those classed as filler materials. Herein, non-cleaning actives include clays, perfumes, perfume delivery technologies, softness technologies, pigments, silicones, antifoams, deposition-enhancement technologies and the like. Cleaning actives do not include phosphates and zeolites.

The cleaning active comprises between 50% and 90% by weight of the cleaning active of a surfactant and between 10% and 20% by weight of the cleaning active of non-surfactant cleaning active.

The surfactant present in the cleaning active may comprise an anionic surfactant, preferably comprises a lamellar liquid crystal anionic surfactant. The anionic surfactant preferably comprises a linear alkylbenzene sulphonate, an alkyl sulphate or a mixture thereof, most preferably a lamellar liquid crystal alkylbenzene sulphonate, a lamellar liquid crystal alkyl sulphate or a mixture thereof. The anionic surfactant may be present in the form of a particle, preferably selected from a spray dried particle, an agglomerate, an extrudate or a mixture thereof.

By ‘lamellar liquid crystal’ we herein mean the surfactant molecules are organised in stacks of bilayers of surfactant in the melted state separated by thin layers of solvent. This structure has both liquid properties in term of flowability as well as solid properties in term of being structured. The structure is characterised by its d-spacing, the sum of the bilayer thickness and the solvent layer between sheets. The repetition and periodicity of this structure yields to sharp x-ray diffraction peaks characteristic of crystal phases. The cleaning active may comprise at least 50%, or at least 75% or at least 95% by weight of the cleaning active of anionic surfactant, preferably linear alkylbenzene sulphonate, most preferably lamellar liquid crystal alkylbenzene sulphonate. The linear alkylbenzene sulphonate is preferably non-amine neutralised.

Non-amine neutralized linear alkylbenzene sulphonates are those in which the linear alkylbenzene sulphonic acid is neutralized to the correspond linear alkylbenzene sulphonate salt using a neutralizing material other than an amine. Non-limiting examples of such neutralizing groups include sodium, potassium, magnesium and mixtures thereof.

The surfactant present in the cleaning active may comprise an amine neutralized anionic surfactant, preferably an amine neutralized linear alkylbenzene sulphonate, an amine neutralized alkyl sulphate or a mixture thereof. The liquid laundry detergent composition may comprise an amine neutralized anionic surfactant in the solid phase, liquid phase or both.

Exemplary linear alkylbenzene sulphonates are C₁₀-C₁₆ alkyl benzene sulfonic acids, or C₁₁-C ₁₄ alkyl benzene sulfonic acids. By ‘linear’, we herein mean the alkyl group is linear. Alkyl benzene sulfonates are well known in the art. Especially useful are the sodium, potassium and magnesium linear straight chain alkylbenzene sulfonates in which the average number of carbon atoms in the alkyl group is from about 11 to 14.

The surfactant present in the cleaning active may comprise an alkyl sulphate anionic surfactant. The alkyl sulphate may comprise lamellar liquid crystal alkyl sulphate. The alkyl sulphate anionic surfactant may be alkoxylated or non-alkoxylated or a mixture thereof. The alkyl sulphate anionic surfactant may be a C₁₀-C₂₀ primary, branched-chain and random alkyl sulfates (AS), including predominantly C₁₂ alkyl sulfates. Alternatively, the alkyl sulphate anionic surfactant may be a C₁₀-C₁₈ secondary (2,3) alkyl sulfates. Alternatively, the alkyl sulphate anionic surfactant may be a C₁₀-C₁₈ alkyl alkoxy sulfates (AEₓS) wherein x is from 1-30. Alternatively, the alkyl sulphate anionic surfactant may be a mixture of all the above alkyl sulphate anionic surfactants. Non-limiting examples of suitable cations for the alkyl sulphate anionic surfactant include sodium, potassium, ammonium, amine and mixtures thereof.

The non-surfactant cleaning active may comprise a cellulosic polymer, a polycarboxylate polymer, a soil release polymer, a brightener, an enzyme, a chelant, or a mixture thereof.

The non-surfactant cleaning active may comprise a polyester soil release polymer. The cleaning active may comprise at least 5% by weight of the composition of polyester soil release polymer. The solid phase may comprise between 1% and 5%, or even between 1% and 2% by weight of the soild phase of a soil release polymer. The liquid laundry detergent composition may comprise between 0.5% and 2.5% or even 0.75% and 2% by weight of the liquid laundry detergent composition of a polyester soil release polymer. Suitable polyester soil release polymers may be selected from terephthalate polymers, amine polymers or mixtures thereof. Suitable polyester soil release polymers may have a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr-CO—]_{c} (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is H, Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or any mixture thereof;

R¹, R², R³, R⁴, R⁵ and R⁶ are independently selected from H or C₁-C₁₈ n- or iso-alkyl; and R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable polyester soil release polymers may be terephthalate polymers having the structure of formula (I) or (II) above.

Suitable polyester soil release polymers include the Repel-o-tex series of polymers such as Repel-o-tex SF2 (Rhodia) and/or the Texcare series of polymers such as Texcare SRA300 (Clariant).

Suitable amine polymers include polyethylene imine polymers, such as alkoxylated polyalkyleneimines, optionally comprising a polyethylene and/or polypropylene oxide block.

The non-surfactant cleaning active may comprise a cellulosic polymers. The cleaning active may comprise at least 5% by weight of the composition of cellulosic polymer. The solid phase may comprise between 1% and 5%, or even between 1% and 2% by weight of the solid phase of a cellulosic polymer. The liquid laundry detergent composition may comprise between 0.5% and 2.5% or even 0.75% and 2% by weight of the liquid laundry detergent composition of a cellulosic polymer

The cellulosic polymer may be selected from alkyl cellulose, alkyl alkoxyalkyl cellulose, carboxyalkyl cellulose, alkyl carboxyalkyl, and any combination thereof. Suitable cellulosic polymers are selected from carboxymethyl cellulose, methyl cellulose, methyl hydroxyethyl cellulose, methyl carboxymethyl cellulose, and mixtures thereof. The carboxymethyl cellulose can have a degree of carboxymethyl substitution from 0.5 to 0.9 and a molecular weight from 100,000 Da to 300,000 Da. Another suitable cellulosic polymer is hydrophobically modified carboxymethyl cellulose, such as Finnfix SH-1 (CP Kelco).

Other suitable cellulosic polymers may have a degree of substitution (DS) of from 0.01 to 0.99 and a degree of blockiness (DB) such that either DS+DB is of at least 1.00 or DB+2DS-DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

The non-surfactant cleaning active may comprise a brightener. The cleaning active may comprise at least 5% by weight of the composition of a brightener. The solid phase may comprise between 1% and 5%, or even between 1% and 2% by weight of the solid phase of a brightener. The liquid laundry detergent composition may comprise between 0.5% and 2.5% or even 0.75% and 2% by weight of the liquid laundry detergent composition of a brightener. The brightener may comprise stilbenes, such as brightener 15. Other suitable brighteners are hydrophobic brighteners, and brightener 49. The brightener may be in micronized particulate form, having a weight average particle size in the range of from 3 to 50 micrometers, or from 3 micrometers to 30 micrometers, or from 3 to 20 micrometers. The brightener can be alpha or beta crystalline form.

Suitable brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5- triazin-2-y)]; amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′- bis(2-sulfostyryl)biphenyl. A suitable fluorescent brightener is C.I. Fluorescent Brightener 260, which may be used in its beta or alpha crystalline forms, or a mixture of these forms.

The non-surfactant cleaning active may comprise an enzyme. The cleaning active may comprise at least 5% by weight of the composition of an enzyme. The solid phase may comprise between 1% and 5%, or even between 1% and 2% by weight of the solid phase of an enzyme. The liquid laundry detergent composition may comprise between 0.5% and 2.5% or even 0.75% and 2% by weight of the liquid laundry detergent composition of an enzyme. The enzyme may be selected from the group comprising hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The non-surfactant cleaning active may comprise a chelant. The composition may comprise from about 0.1% by weight of the compositions herein to about 15%, or even from about 3% to about 15% by weight of the compositions herein of a chelant. Suitable chelants may be selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′- disuccinic acid or salt thereof. The ethylene diamine-N′N′-disuccinic acid may be in S,S enantiomeric form. The composition may comprise 4,5-dihydroxy-m-benzenedisulfonic acid disodium salt, glutamic acid-N,N-diacetic acid (GLDA) and/or salts thereof, 2-hydroxypyridine-1-oxide, Trilon P™ available from BASF, Ludwigshafen, Germany.

Chelants may also act as calcium carbonate crystal growth inhibitors. Suitable calcium carbonate crystal growth inhibitors may be selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The non-surfactant cleaning active may comprise a polycarboxylate polymer. The cleaning active may comprise at least 5% by weight of the composition of a polycarboxylate polymer. The solid phase may comprise between 1% and 5%, or even between 1% and 2% by weight of the solid phase of a polycarboxylate polymer. The liquid laundry detergent composition may comprise between 0.5% and 2.5% or even 0.75% and 2% by weight of the liquid laundry detergent composition of a polycarboxylate.

The polycarboxylate polymer may comprise a maleate/acrylate random copolymer or polyacrylate homopolymer. Suitable polycarboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable polycarboxylate polymer is a co-polymer that comprises: (i) from 50 to less than 98 wt% structural units derived from one or more monomers comprising carboxyl groups; (ii) from 1 to less than 49 wt% structural units derived from one or more monomers comprising sulfonate moieties; and (iii) from 1 to 49 wt% structural units derived from one or more types of monomers selected from ether bond-containing monomers represented by formulas (I) and (II):

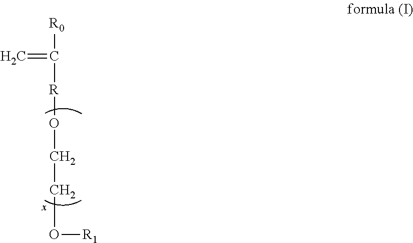

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

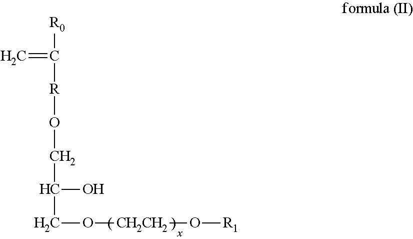

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

### Amine

The detergent composition comprises less than 5% by weight of the composition of a hydroxyl-containing amine compound, or even from 0.1% to 5%, or even from 0.1% to 4% by weight of the composition of a hydroxyl-containing amine compound. By ‘hydroxyl-containing amine compound’ we herein mean a compound comprising an alcohol (OH) group and an amine group. The hydroxyl-containing amine compound may be selected from monoethanolamine, triethanolamine, diisopropanolamine, triisopropanolamine, Monoamino hexanol, 2-[(2-methoxyethyl) methylamino]-ethanol, Propanolamine, N-Methylethanolamine, diethanolamine, Monobutanol amine, Isobutanolamine, Monopentanol amine, 1-Amino-3-(2-methoxyethoxy)-2-propanol, 2-Methyl-4-(methylamino)- 2-butanol, 6-amino-1-hexanol, Heptaminol, Isoetarine, Norepinephrine, Sphingosine, Phenylpropanolamine and mixtures thereof.

The hydroxyl-containing amine compound may be selected from the group comprising monoethanol amine, triethanolamine and mixtures thereof.

Preferably, the hydroxyl-containing amine compound has a molecular weight of less than 500, or even less than 250.

The detergent composition may comprise other amine containing compounds.

Suitable amines include diamines. Diamines useful herein can be defined by the following structure:

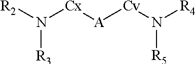

wherein R2-5 are independently selected from H, methyl, —CH3CH2, and ethylene oxides; Cx and Cv are independently selected from methylene groups or branched alkyl groups where x+y is from about 3 to about 6; and A is optionally present and is selected from electron donating or withdrawing moieties chosen to adjust the diamine pKa's to the desired range. If A is present, then x and y must both be 1 or greater.

Diamines can be organic diamines with a molecular weight less than or equal to 400 g/mol. It is preferred that these diamines have the formula:

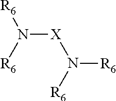

wherein each R6 is independently selected from the group consisting of hydrogen, C1-C4 linear or branched alkyl, alkyleneoxy having the formula:

—(—R₇O—)ₘ—R₈

wherein R7 is C2-C4 linear or branched alkylene, and mixtures thereof ; R8 is hydrogen, C1-C4 alkyl, and mixtures thereof ; m is from 1 to about 10; X is a unit selected from:
i) C3-C10 linear alkylene, C3-C10 branched alkylene, an alkyleneoxyalkylene having the formula:

—(—R₇O—)ₘ—R₇—

wherein R7 and m are the same as defined herein above;
ii) C3-C10 linear alkylene, C3-C10 branched linear alkylene, C6-C10 arylene, wherein said unit comprises one or more electron donating or electron withdrawing moieties which provide said diamine with a pKa greater than about 8; and
iii) mixtures of (i) and (ii)
   provided said diamine has a pKa of at least about 8.

Examples of preferred diamines include the following: dimethyl aminopropyl amine, 1,6-hexane diamine, 1,3 propane diamine, 2-methyl 1,5 pentane diamine (available under the trade name Dytec A), 1,3-Pentanediamine (available under the trade name Dytek EP), 1,3diaminobutane, 1,2-bis (2-aminoethoxy) ethane, (available under the trade name Jeffamine EDR 148) and mixtures thereof.

The amine can comprise a triamine. Especially preferred diamines or triamines can be those organic polyetheramines compositions that are lipophilic. It is preferred that these diamines have the formula I or II or a mixture thereof

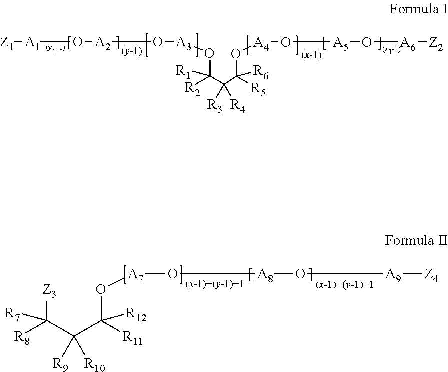

where each of R1-R12 is independently selected from H, alkyl, cycloalkyl, aryl, alkylaryl, or arylalkyl, where at least one of R1-R6 and at least one of R7-R12 is different from H, each of A1-A9 is independently selected from linear or branched alkylenes having 2 to 18 carbon atoms, each of Z1-Z4 is independently selected from OH or NH2, where at least one of Z1-Z2 and at least one of Z3-Z4 is NH2, where the sum of x+y is in the range of about 2 to about 200, where x≧1 and y≧1, and the sum of x1+y1 is in the range of about 2 to about 200, where x1≧1 and y1≧1.

Examples of preferred lipophilic diamines include the following

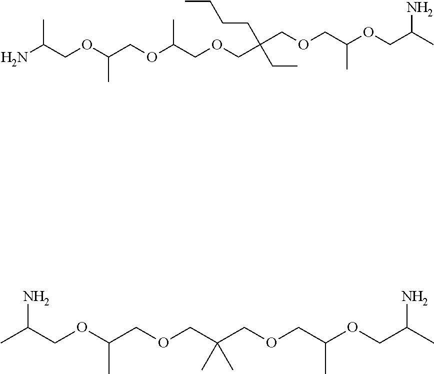

Preferred triamines can be those organic polyetheramines compositions that are lipophilic. It is preferred that these triamines have the formula III

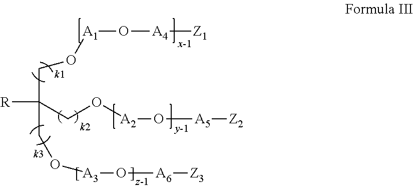

Wherein R is selected from H or a C1-C6 alkyl group, each of k1, k2, and k3 is independently selected from 0, 1, 2, 3, 4, 5, or 6, each of A1, A2, A3, A4, A5, and A6 is independently selected from a linear or branched alkylene group having from about 2 to about 18 carbon atoms or mixtures thereof, x≧1, y≧1, and z≧1, and the sum of x+y+z is in the range of from about 3 to about 100, and each of Z1, Z2, and Z3 is independently selected from NH2 or OH, where at least two of Z1, Z2, and Z3 are NH2.

Examples of preferred lipophilic triamines are

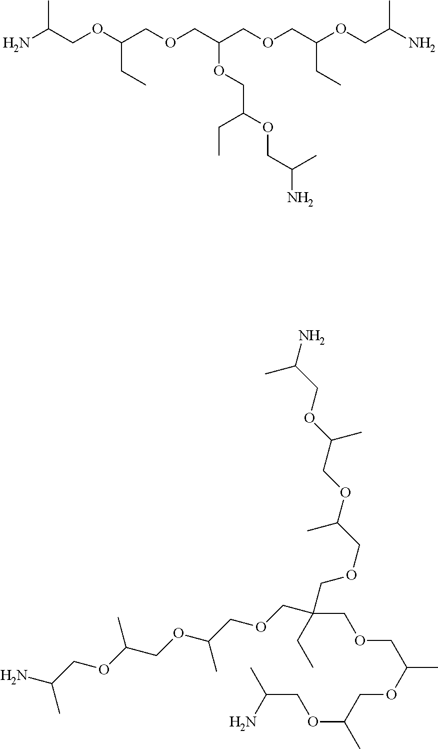 [SMILES: CCC(COCC(COCC(CC)OCC(C)N)OCC(CC)OCC(C)N)OCC(C)N ; CCC(COCC(C)OCC(C)OCC(C)N)(COCC(C)OCC(C)OCC(C)N)COCC(C)OCC(C)OCC(C)N]

### Structurant

The composition of the present invention may comprises less than 2% by weight of the composition of a structurant. If a structurant is present, preferably the composition comprises from 0.05% to 2%, preferably from 0.1% to 1% by weight of a structurant. The structurant may be selected from non-polymeric or polymeric structurants. The structurant may be a non-polymeric structurant, preferably a crystallisable glyceride. The structurant may be a polymeric structurant, preferably a fibre based polymeric structurant, more preferably a cellulose fibre-based structurant. The structurant may be selected from crystallisable glyceride, cellulose-fibre based structurants, TiO₂, silica and mixtures thereof.

Suitable structurants are preferably ingredients which impart a sufficient yield stress or low shear viscosity to stabilize the liquid laundry detergent composition independently from, or extrinsic from, any structuring effect of the detersive surfactants of the composition. Preferably, they impart to the laundry detergent composition a high shear viscosity at 20 sec-1 at 21° C. of from 1 to 1500 cps and a viscosity at low shear (0.05 sec-1 at 21° C.) of greater than 5000 cps. The viscosity is measured using an AR 550 rheometer from TA instruments using a plate steel spindle at 40 mm diameter and a gap size of 500 p.m. The high shear viscosity at 20 s⁻¹ and low shear viscosity at 0.5 s⁻¹ can be obtained from a logarithmic shear rate sweep from 0.1-1 to 25-1 in 3 minutes time at 21° C.

The composition may comprise a non-polymeric crystalline, hydroxyl functional structurant. Such non-polymeric crystalline, hydroxyl functional structurants generally comprise a cystallizable glyceride which can be pre-emulsified to aid dispersion into the final liquid laundry detergent composition. A non-limiting example of such a pre-emulsified external structuring system comprises: (a) crystallizable glyceride(s); (b) anionic surfactant; and (c) water and optionally, non-aminofunctional organic solvents. Each of these components is discussed in detail below.

The structurant may be a polymeric crystalline, hydroxy-functional structurant that comprises a crystallizable glyceride, preferably hydrogenated castor oil or “HCO”. HCO as used herein most generally can be any hydrogenated castor oil or derivative thereof, provided that it is capable of crystallizing in the non-polymeric crystalline, hydroxy-functional structurant premix. Castor oils may include glycerides, especially triglycerides, comprising C₁₀ to C₂₂ alkyl or alkenyl moieties which incorporate a hydroxyl group. Hydrogenation of castor oil, to make HCO, converts the double bonds which may be present in the starting oil as ricinoleyl moieties. As such, the ricinoleyl moieties are converted into saturated hydroxyalkyl moieties, e.g., hydroxystearyl. The HCO herein may be selected from: trihydroxystearin; dihydroxystearin; and mixtures thereof. The HCO may be processed in any suitable starting form, including, but not limited to those selected from solid, molten and mixtures thereof. HCO is typically present at a level of from 2% to 10%, from 3% to 8%, or from 4% to 6% by weight in the external structuring system. The corresponding percentage of hydrogenated castor oil delivered into a finished laundry detergent product may be below 1.0%, typically from 0.1% to 0.8%. HCO may be present at a level of between 0.01% and 1%, or even between 0.05% and 0.8% by weight of the laundry detergent composition.

HCO of use in the present invention includes those that are commercially available. Non-limiting examples of commercially available HCO of use in the present invention include: THIXCIN® from Rheox, Inc. Further examples of useful HCO may be found in U.S. Pat. No. 5,340,390.

While the use of hydrogenated castor oil is preferred, any crystallisable glyceride can be used within the scope of the invention. Preferred crystallisable glyceride(s) have a melting point of from 40° C. to 100° C.

The structurant may comprise a fibre-based structurant. The structurant may comprise a microfibrillated cellulose (MFC), which is a material composed of nanosized cellulose fibrils, typically having a high aspect ratio (ratio of length to cross dimension). Typical lateral dimensions are 1 to 100, or 5 to 20 nanometres, and longitudinal dimension is in a wide range from nanometres to several microns. For improved structuring, the microfibrillated cellulose preferably has an average aspect ratio (lid) of from 50 to 200,000, more preferably from 100 to 10,000. Microfibrillated cellulose can be derived from any suitable source, including bacterial cellulose, citrus fibers, and vegetables such as sugar beet, chicory root, potato, carrot, and the like.

The structurant may be selected from the group consisting of titanium dioxide, tin dioxide, any forms of modified TiO₂, TiO₂ or stannic oxide, bismuth oxychloride or bismuth oxychloride coated TiO₂, silica coated TiO₂ or metal oxide coated TiO₂ and mixtures thereof. Modified TiO₂ may comprise carbon modified TiO₂, metallic doped TiO₂ or mixtures thereof. Metallic doped TiO₂ may be selected from platinum doped TiO₂, Rhodium doped TiO₂.

The structurant may comprise silica. Those skilled in the art will know suitable silica materials to use. The silica may comprise fumed silica.

### Water and Equilibrium Relative Humidity

The liquid laundry detergent composition may comprise between 0.5% and 50% by weight of the composition of water. The liquid laundry detergent composition may comprise between 0.5% and 30%, or even between 0.5% and 15% by weight of the composition of water.

The equilibrium relative humidity of the liquid laundry detergent composition may be less than 65% at 20° C.

A preferred method for measuring the eRH of the composition is via the composition eRH test. The composition eRH test comprises the steps of adding a sample of the composition to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

### Adjunct Ingredients

The liquid laundry detergent composition may comprise an adjunct ingredient. The adjunct ingredient may be selected from the group comprising bleach, bleach catalyst, dye, hueing dye, cleaning polymers including alkoxylated polyamines and polyethyleneimines, surfactant, solvent, dye transfer inhibitors, perfume, encapsulated perfume, and mixtures thereof. Hueing Dye: The liquid laundry detergent composition may comprise a hueing dye. The hueing dyes employed in the present laundry care compositions may comprise polymeric or non-polymeric dyes, pigments, or mixtures thereof. Preferably the hueing dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred. The hueing dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof.

The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

### Water-Soluble Pouch

The liquid laundry detergent composition may be present in a water-soluble unit dose article wherein the composition comprises between 0.5% and 15%, preferably between 0.5% and 12%, more preferably between 0.5% and 10% by weight of the composition of water. In such an embodiment, the water-soluble unit dose article comprises at least one water-soluble film shaped such that the unit-dose article comprises at least one internal compartment surrounded by the water-soluble film. The at least one compartment comprises the liquid laundry detergent composition. The water-soluble film is sealed such that the liquid laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:
5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000- 40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

Of the total PVA resin content in the film described herein, the PVA resin can comprise about 30 to about 85 wt% of the first PVA polymer, or about 45 to about 55 wt% of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone- plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Method of Making

The liquid laundry detergent composition of the present invention may be made using any suitable manufacturing techniques known in the art. Those skilled in the art would know appropriate methods and equipment to make the composition according to the present invention.

A preferred process comprises the step of adding the solid phase wherein the solid phase comprises particles wherein the particles have a mean particle size distribution of less than 500 μm, or even less than 400 μm, or even less than 250 μm, or even less than 100 μm.

The solid phase may be pre-dispersed into a volume of liquid to form a predispersion. The predispersion is then added to other ingredients to form the liquid laundry detergent composition.

The solid phase may be pre-dispersed into a volume of the alcohol to form a predispersion. The predispersion is then added to other ingredients to form the liquid laundry detergent composition.

HCO premix may be formed by melting HCO and adding into a small volume of a hot liquid laundry detergent composition wherein the composition does not comprise enzymes or perfume materials. The HCO premix is then added to other ingredients to form the liquid laundry detergent composition.

### Method of Use

The composition or unit dose article of the present invention can be added to a wash liquor to which laundry is already present, or to which laundry is added. It may be used in an washing machine operation and added directly to the drum or to the dispenser drawer. The washing machine may be an automatic or semi-automatic washing machine. It may be used in combination with other laundry detergent compositions such as fabric softeners or stain removers. It may be used as pre-treat composition on a stain prior to being added to a wash liquor.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

The viscosity of various compositions were compared. The following compositions were prepared;

TABLE 1

Compositions (wt %)

| | A | B | C |
|---|---|---|---|
| water | 7.16 | 7.16 | 7.44 |
| Dipropylene glycol | 14.66 | 14.66 | 31.19 |
| 1,2-propanediol | | 10.00 | |
| Dipropylene glycol n-butyl ether | 9.80 | 9.80 | |
| Glycerol | 15.00 | 5.00 | 5.00 |
| Linear alkylbenzene sulphonate | | | 23.59 |
| neutralized with monoethanolamine | | | |
| Linear alkylbenzene sulphonate | 23.59 | 23.59 | |
| neutralized with sodium carbonate | | | |
| Ethoxylated polyethyleneimine | 2.16 | 2.16 | 2.16 |
| Alkyl sulphate with an average | | | 11.00 |
| degree of ethoxylation of 3, | | | |
| neutralized with monoethanolamine | | | |
| Alkyl sulphate with an average | 11.00 | 11.00 | |
| degree of ethoxylation of 3, | | | |
| neutralized with sodium carbonate | | | |
| HEDP | 1.81 | 1.81 | 1.81 |
| Amphiphilic graft copolymer | 2.72 | 2.72 | 2.72 |
| Brightener 49 | 0.24 | 0.24 | 0.24 |
| Soil release polymer commercially | 0.32 | 0.32 | 0.32 |
| available from Clariant as SRA-300 | | | |
| Carboxymethyl cellulose | 1.07 | 1.07 | 1.07 |
| Siloxane polymeric suds suppressor | 0.13 | 0.13 | 0.13 |
| Perfume | 2.68 | 2.68 | 2.68 |
| protease | 0.10 | 0.10 | 0.10 |
| TiO2 | 0.50 | 0.50 | 0.50 |
| palm kernel fatty acid | 3.26 | 3.26 | 3.26 |
| Guerbet alcohol non-ionic | 0.56 | 0.56 | 0.56 |
| surfactant commercially available | | | |
| from BASF as Lutensol XL100 | | | |
| minors | 2.36 | 2.36 | 2.77 |

The compositions were made by preparing a 1 L beaker having an IKA Eurostar 200 mixer with 10 cm impeller. This was operated at 250 rpm. To the beaker with the roatating impellar, the solvent materials were added, followed by the surfactant materials. Once these had dispersed, the polymers and salts were added. The pH of the composition was adjusted using NaOH to approximately & (measured using a Sartorius PT-10 pH meter). Remaining ingredients were then added and mixed. All materials were weighed out using a Mettler Toledo PB3002-S balance.

Composition C comprised 6.25% by weight of composition C of monoethanolamine. Compositions A and B comprised no monoethanolamine.

Composition B comprised approximately 12-13% by weight of composition B of the water-soluble solid phase.

The viscosity of the compositions were then measured using a Rheometer DHR1 from TA instruments using a gap of 1000 μm at 20° C. Samples were equilibrated for 1 min at 0.05 s⁻¹ followed by a measured flow curve from 0.05 s⁻¹ to 1200 s⁻¹ over 10 mins. Results for 0.05 s⁻¹ and 1000 s⁻¹ are shown in Table 2.

TABLE 2

| | 0.05 s−1 | 1000 s−1 |
|---|---|---|
| | mPa · s | mPa · s |
| A | 1560 | 870 |
| B | 1112 | 413 |
| C | 1310 | 315 |

Shear at 0.05 s⁻¹ corresponds to that experienced by the composition during pouring of the composition by the consumer. Shear at 1000 s⁻¹ corresponds to that experienced by the composition during manufacture.

Composition C which comprises 6.25% monoethanolamine shows an acceptable viscosity profile at low and high shear corresponding to consumer pouring shear and process dosing shear.

However, when the monoethanolamine is removed in composition A (and correspondingly the surfactants are neutralized with sodium carbonate), there is an increase in viscosity to unacceptable levels.

Composition B corresponds to the present invention in which the monoethanolamine has been removed and the surfactants neutralized with sodium carbonate, but also 1,2-propandiol has been added. The viscosity returns to acceptable levels.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
a. a liquid phase;
b. between about 10% and about 50% by weight of the composition of a water-soluble solid phase, wherein the solid phase comprises at least about 30% by weight of the solid phase of a cleaning active, wherein the cleaning active comprises between about 50% and about 90% by weight of the cleaning active of a surfactant and between about 10% and about 20% by weight of the cleaning active of non-surfactant cleaning active,
wherein the solid phase is dispersed within the liquid phase and wherein the water-soluble solid phase is defined as the solid obtained when the liquid laundry detergent composition is centrifuged at about 1200 G for about 10 mins; and
wherein the liquid phase comprises between about 5% and about 40% by weight of the liquid of an alcohol selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof; and
wherein the composition comprises from about 10% to about 50% by weight of the composition of a non-amine neutralised anionic surfactant and wherein the liquid laundry detergent composition comprises less than about 10% by weight of the liquid laundry detergent composition of an amine-neutralised anionic surfactant; and
wherein the composition has an equilibrium relative humidity of less than about 65% at about 20° C. as measured via the composition eRH test described herein; and
wherein the composition comprises less than about 5% by weight of the composition of a hydroxyl-containing amine compound.

2. The detergent composition according to claim 1, wherein the composition comprises between about 10% and about 40% by weight of the composition of the water-soluble solid phase.

3. The detergent composition according to claim 1, wherein the solid phase comprises at least about 40% by weight of the solid phase of a cleaning active.

4. The detergent composition according to claim 3, wherein the solid phase comprises at least about 50% by weight of the solid phase of a cleaning active.

5. The detergent composition according to claim 1, wherein the surfactant comprises an anionic surfactant.

6. The detergent composition according to claim 5, wherein the anionic surfactant comprises a linear alkylbenzene sulphonate, an alkyl sulphate, or a mixture thereof.

7. The detergent composition according to claim 6, wherein the anionic surfactant comprises a lamellar liquid crystal alkylbenzene sulphonate, a lamellar liquid crystal alkyl sulphate, or a mixture thereof.

8. The detergent composition according to claim 1, wherein the non-surfactant cleaning active comprises a cellulosic polymer, a polycarboxylate polymer, a soil release polymer, a brightener, an enzyme or a mixture thereof.

9. The detergent composition according to claim 1, wherein the liquid phase comprises between about 5% and about 20% by weight of the liquid phase of the alcohol.

10. The detergent composition according to claim 1, wherein the liquid phase comprises alkyl sulphate anionic surfactant, a natural or synthetically derived fatty alcohol ethoxylate non-ionic surfactant, or a mixture thereof.

11. The detergent composition according to claim 1 wherein the hydroxyl-containing amine compound is selected from the group consisting of monoethanol amine, triethanolamine, and mixtures thereof.

12. The detergent composition according to claim 1, comprising less than 2% by weight of the composition of a structurant, wherein the structurant is selected from crystallisable glyceride, cellulose-fibre based structurants, TiO₂, silica, and mixtures thereof.

13. The detergent composition according to claim 1, wherein the solid phase comprises a particle having a mean particle size distribution of between about 2 μm and about 50 μ.

14. The detergent composition according to claim 1 comprising a perfume raw material, wherein the perfume raw material is selected from aldehydes, ketones or a mixture thereof.

15. The detergent composition according to claim 1 comprising an adjunct ingredient, wherein the adjunct ingredient is selected from the group comprising bleach, bleach catalyst, dye, hueing dye, cleaning polymers including alkoxylated polyamines and polyethyleneimines, surfactant, solvent, dye transfer inhibitors, chelant, perfume, encapsulated perfume, and mixtures thereof.

16. A water-soluble unit dose article comprising a water-soluble film and a detergent composition according to claim 1, wherein the composition comprises between about 0.5% and about 15% by weight of the composition of water.

17. The unit dose article according to claim 16 wherein the unit dose article comprises at least two compartments..

18. The unit dose article according to claim 17 wherein the unit dose article comprises at least three compartments.

19. The unit dose article according to claim 18 wherein the unit dose article comprises at least four compartments.

20. A process of making a composition according to claim 1, comprising the step of adding the solid phase wherein the solid phase comprises particles wherein the particles have a mean particle size distribution of less than 500 μm.
